(19) United States
(12) Patent Application Publication
(10) Pub. No.: US 2005/0102169 A1
(43) Pub. Date: May 12, 2005

(54) Method for reimbursing qualified over-the- counter medical care products

(76) Inventor: David Wilson, West Bloomfield, MI (US)

Correspondence Address: HARNESS, DICKEY & PIERCE, P.L.C., P.O. BOX 828, BLOOMFIELD HILLS, MI, 48303, US

(21) Appl. No.: 10/779,573

(22) Filed: Feb. 13, 2004

Related U.S. Application Data
(60) Provisional application No. 60/518,776, filed on Nov. 10, 2003.

(51) Int. Cl. G06F 17/60

(52) U.S. Cl. 705/4

(57) ABSTRACT

A method is provided to facilitate reimbursement of a qualified medical care product from a reimbursement account. The method includes: providing an indicator that the qualified medical care product is eligible or may be eligible for reimbursement; providing a reimbursement claim mechanism, such as a claim form, in connection with the qualified medical care product; and reimbursing a submitted reimbursement claim for the qualified medical care product to the plan participant or directly to retailer of the product.

### CROSS-REFERENCE TO RELATED APPLICATIONS

This application claims the benefit of U.S. Provisional Application No. 60/518,776, filed on Nov. 10, 2003. The disclosure of the above application is incorporated herein by reference.

### FIELD OF THE INVENTION

The present invention relates generally to health care spending accounts and, more particularly, to a method for reimbursing qualified over-the-counter medical care products.

### BACKGROUND OF THE INVENTION

On Sep. 3, 2003 the IRS issued Revenue Ruling 2003-102 (“the IRS Ruling”). The IRS Ruling defined IRS guidance on current tax laws providing to employer-sponsored health plans, approval for the reimbursement of qualified over-the-counter medicines, drugs, and devices—on a tax-free benefit basis. Prior to the IRS Ruling, compliant focused administrators and established “Best Practice” within the industry interpreted the applicable law to restrict tax-free reimbursement to medicines and drugs that could only be obtained with a prescription. This change in industry practice is significant and new. It provides an important new employer benefit value to employees who incur the purchase of over-the-counter medicines, drugs or devices for the treatment of a medical condition, as established under the Internal Revenue Code and IRS guidance.

The IRS Ruling and its effective best practice administrative application in the market place present a set of new and unique challenges for all parties. First, a clear and sustained communications program is needed to explain to employees that specific qualified over-the-counter drugs are now reimbursable, tax-free, through their participation in a qualified, reimbursement enabled, employer-sponsored medical plan. Any such communication program must differentiate and specify which over-the-counter medicines, drugs and devices are qualified, or may be qualified, for tax-free reimbursement.

Second, an effective method is needed for manufacturers and retailers to clearly communicate to plan participant-consumers, at the point of purchase, the qualification status of an over-the-counter product in reference to its tax-free reimbursement qualification.

Third, an effective, easy method is needed for employees to submit qualified over-the-counter claims for reimbursement from the medical plan. Likewise, an efficient method is needed for employer-sponsored health plan administrators and record keepers to receive, substantiate, adjudicate and process employee requests for reimbursement of qualified over-the-counter medicines, drugs, and devices.

Fourth, active promotion of the industry standards that clearly defines manufacturer, retailer, employer, plan administrator, employees and record keeper responsibilities are needed to assure compliance and the continued development of best practice methods. The present invention addresses these as well as other concerns and requirements.

### SUMMARY OF THE INVENTION

In accordance with the present invention, a method is provided to facilitate reimbursement of a qualified medical care product from a reimbursement account. The method includes: providing an indicator that the qualified medical care product is eligible for reimbursement; providing a reimbursement claim mechanism, such as a claim form, in connection with the qualified medical care product; and reimbursing a submitted reimbursement claim for the qualified medical care product.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is a flowchart illustrating a method for facilitating reimbursement of a qualified medical care product in accordance with the present invention;

FIGS. 2A and 2B depict exemplary certification marks which certify that a given medical care product is eligible for reimbursement or that it may be eligible for reimbursement, respectively;

FIG. 3 is diagram illustrating an exemplary paper-based reimbursement claim submission method in accordance with the present invention;

FIG. 4 illustrates an exemplary reimbursement claim form in accordance with the present invention; and

FIG. 5 is diagram illustrating an alternative exemplary reimbursement claim submission method in accordance with the present invention.

### DETAILED DESCRIPTION OF THE PREFERRED EMBODIMENTS

Medical plans generally provide coverage for medical expenses incurred by a health care participant and its covered dependants as is well known in the art. Medical plans are typically made available to a health care participant by a health insurance entity as adopted by the employer of the health care participant. Thus, “health care recipient” is used herein to refer to the health care participant (i.e., the employee) and/or its covered dependants.

Medical plans may have various requirements for health care recipients to pay for at least some of their incurred medical expenses. For instance, the medical plan may include an employee deductible which requires a health care recipient to pay for incurred medical expenses on an annual basis up to a predefined maximum amount before benefit payment begins under the medical plan. The medical plan may also include a coinsurance obligation. Once a health care recipient has satisfied their deductible obligation, the medical plan and the health care recipient may be jointly responsible for incurred medical expenses up to some predefined maximum amount. Specifically, the health care recipient is responsible for paying a percentage of incurred medical expenses on an annual basis up to a predefined maximum out-of-pocket amount. The medical plan may further include a preventive or diagnostic component which requires a nominal copay (e.g., $10 per visit) by the health care recipient for these types of services.

Beyond these obligations, the medical plan typically provides complete coverage for any remaining incurred medical plan covered expenses. It is readily understood that only the primary aspects of the medical plan have been discussed herein, but that other ancillary benefits may be incorporated into an exemplary medical plan.

To account for medical expenses that are not covered by the medical plan, the health care plan offering provided by the employer may further include a reimbursement account component. The reimbursement account may take one of three forms. For example, the reimbursement account may be in the form of a flexible spending account as established in accordance with §125 of the Internal Revenue Code. Although the flexible spending account may be funded by contributions from either the health care recipient or the employer of the health care recipient, the flexible spending account is preferably funded by contributions from both the health care recipient and the employer of the health care recipient, where the employer contributions are conditional upon contributions from the health care recipient. For instance, the employer may contribute 30 cents for every dollar contributed by the employee up to some predefined limit. Thus, the employer's matching contribution provides an incentive for the employee to establish a flexible spending account.

Alternatively, the reimbursement account may be in the form of a health care reimbursement arrangement as established in accordance with §105 of the Internal Revenue Code. Unlike the flexible spending accounts, contributions to the health care reimbursement arrangement are only made by the employer.

In yet another example, the reimbursement account may be in the form of a health savings account as established in accordance with §223 of the Internal Revenue Code. Unlike the other two examples, the health savings account must be complemented by a specifically qualified high deductible health plan as defined by the Code. These accounts are more limited in nature but provide another important payment mechanism for health care recipients. Thus, the health care plan may include either a flexible spending account, a health care reimbursement arrangement, a health savings account, or a combination thereof. It should also be noted that specific types of accounts may be offered on a stand alone basis independent from a medical plan. The different types of accounts will generally be referred to herein as “reimbursement accounts”.

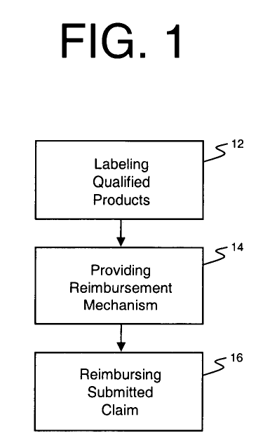

Referring to FIG. 1, a method is provided to facilitate reimbursement of a qualified medical care product from a reimbursement account associated with or independent of a medical plan. Qualified or potentially qualified medical care products generally include over-the-counter medicines, drugs or medical devices which are deemed qualified under the Internal Revenue Code.

First, qualified medical care products are associated with an indicator that the product is eligible for reimbursement as shown at step 12. Preferably, a unique, universally recognized indicator is placed on all over-the-counter medical care products which are, or may be, qualified for reimbursement. The indicator is designed to capture the attention of a customer in a retail environment and to communicate in a succinct manner that a given product is eligible for reimbursement.

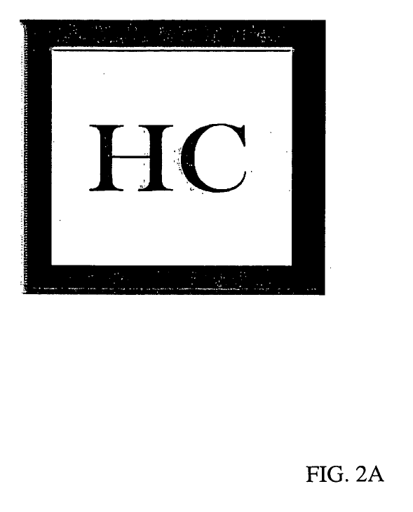

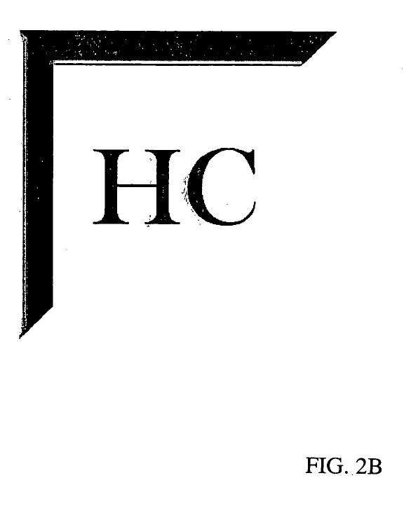

In an exemplary embodiment, a certification mark may be placed on the outside packaging or otherwise associated with the medical care product. In this instance, the certification mark certifies that the medical care product is eligible for reimbursement. Exemplary certification marks are illustrated in FIGS. 2A and 2B. However, it is readily understood that other types of indicators are also within the scope of the present invention.

Alternatively, an indicator that the product is eligible for reimbursement may be affixed to general advertising (e.g., as found in a magazine) or an advertising display proximate to the medical care product or on the shelving that supports the medical care product. In these instances, the indicator must also clearly identify which products are eligible for reimbursement. It is envisioned that other ways of identifying qualified medical care products are also within the broader aspects of the present invention.

Next, a reimbursement claim mechanism is provided as shown at step 14. The reimbursement claim mechanism provides an efficient manner by which the participant can obtain reimbursement for the purchased product. Once the participant has selected a qualified medical care product to be purchased, a reimbursement claim is submitted by the participant using the reimbursement claim mechanism to an entity responsible for administering reimbursement accounts under the applicable medical plan. Upon receipt of the reimbursement claim, responsible entity processes the reimbursement claims and, if applicable, reimburses the participant as shown at step 16. For simplicity, the responsible entity is designated as the record keeper. The record keeper is preferably a third party that administers an employee benefit program on behalf of the health care recipient's employer as is well known in the art. However, it is readily understood that this function may be performed by either the employer or the health insurance entity, such that either of these two parties also falls within the scope of the term record keeper.

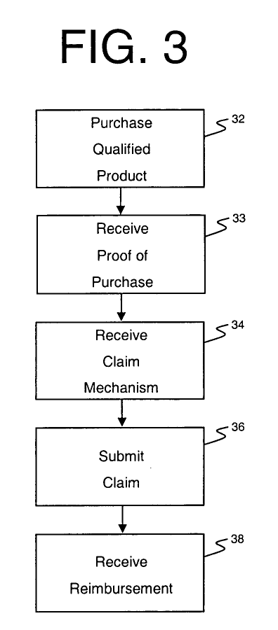

Two exemplary reimbursement mechanisms are further explained below. First, a paper-based claim submission method is described in relation to FIG. 3. To initiate the process, a medical plan participant selects various products to be purchased from a pharmacy or other type of retailer. For illustration purposes, the selected products includes at least one qualified over-the-counter medical care product. The participant then presents the selected products for purchase at an appropriate point-of-sale location for the merchant. Although the purchase is likely to occur at a conventional “bricks and mortar” retailer, it is envisioned that the purchase may also be transacted in other ways, such as over the phone or via the Internet.

To transact a purchase, all of the selected products are tabulated and then the participant pays for all of the purchased products as shown at step 32. During the purchase transaction, the participant is presented at step 33 with a proof of purchase for the qualified medical care products. In one exemplary embodiment, the participant may be presented with a purchase stamp that identifies the purchase date or period of purchase (e.g., month and year) and which may be affixed to a reimbursement claim form as further described below. However, it is readily understood that other forms for a proof of purchase (i.e., a printed sales receipt) are also within the scope of the present invention.

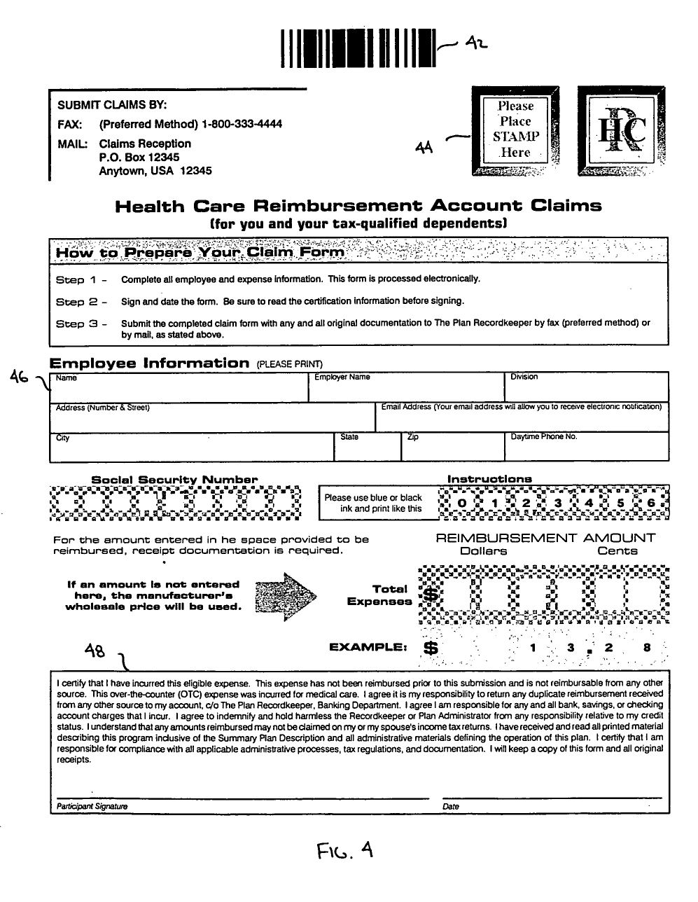

The participant is also provided at step 34 with a reimbursement claim mechanism as part of the purchase transaction. In an exemplary embodiment, the reimbursement claim mechanism is a claim form which is placed in the packaging or otherwise associated with the qualified product. Although not limited thereto, a suitable claim form is illustrated in FIG. 4. The claim form is generally designed to minimally require input from the participant. For instance, the claim form preferably identifies the specific product purchased by the participant, such as via a bar code as shown at 42. In another instance, the claim form identifies a location at which to affix a proof of purchase stamp at 44. In addition, the claim form may request that the participant identify the date of purchase as well as the purchase price for the product. The claim form may also request the participant to provide some identifying information generally shown at 46, such as name, address, employee number, social security number, medical plan identifier or some combination thereof. Lastly, the claim form provides a signature block which enables the participant to certify the purchase as shown at 48. The signature block may include appropriate certification language as well as other statements which are agreed to by the participant.

To receive reimbursement for qualified products, the participant completes the provided claim form and submits it at step 36 to the record keeper. The claim form may be submitted by facsimile, mail or other medium to the record keeper. Upon receipt of the claim form, the reimbursement request is processed by the record keeper as shown at step 38.

When qualified funds are available in an applicable reimbursement account, the participant is reimbursed for the purchase of the qualified products. The reimbursement amount generally correlates to the substantiated purchase price for the product. In the event the purchase price is not substantiated, then the participant is reimbursed the lower of either the requested amount or the manufacturer's wholesale price which may be stored in the record keeper's administrative system and updated periodically in accordance with the employer's medical plan. It is readily understood that reimbursement may be provided in various ways (e.g., direct deposit or check sent via mail) to the participant.

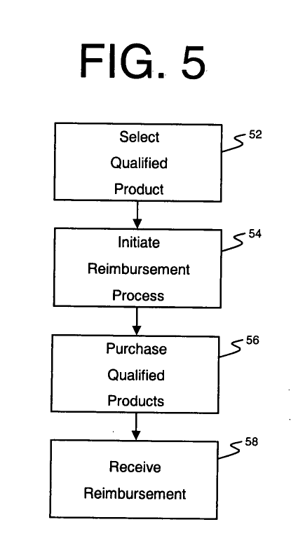

In another instance, an exemplary automated claim submission method is set forth in relation to FIG. 5. Similarly, a medical plan participant initiates the process by selecting various products to be purchased, including at least one qualified over-the-counter medical care product. The participant then presents the selected products at step 52 for purchase at an appropriate point-of-sale location.

To enable reimbursement, qualified or potentially qualified products are identified and separated from the remainder of the selected products. Qualified or potentially qualified products may be separated manually by the participant or a retailer's employee or, alternatively, separated automatically by a transactional system being employed to complete the purchase transaction. In either instance, the participant initiates the reimbursement process at the point-of-sale as shown at step 54.

In an exemplary embodiment, the participant presents a card or other similar instrument to the retailer, the card having a unique identifier embossed thereon, magnetically encoded or otherwise embodied therein. The unique identifier is preferably a participant identifying number or some other identifying information linking the participant and the reimbursement accounts associated with participant's medical plan. Although the identifying information may be transmitted in real-time to the record keeper, it is more likely captured at the point-of-sale and subsequently communicated in a batched manner to the record keeper. To the extent that a retailer accepts customers from multiple record keepers, the card may also include an identifier for the applicable record keeper. Although a card preferably serves as the reimbursement claim mechanism, it is readily understood that other techniques for initiating the reimbursement process at the point-of-sale are also within the scope of the present invention.

Next, all of the selected products are tabulated. In one instance, the participant pays for all of the purchased products at step 56 and is subsequently reimbursed for the qualified products as shown at step 58. In another instance, the participant is not required to pay for qualified or potentially qualified products. Rather, the retailer is reimbursed by the record keeper as further described below. In this instance, the remainder of the selected products are tabulated and paid for by the participant in a conventional manner.

On a period basis, the retailer notifies the record keeper of each of the qualified transactions handled by the retailer. For each qualified transaction, it is readily understood that the record keeper is notified of the purchased product, date of purchase, and purchase price. Preferably, an electronic file containing a record for each such transaction is transmitted to the record keeper for subsequent processing. Each qualified transaction is then processed by the record keeper as described above. Consequently, the participant is reimbursed for the purchase of the qualified products. As noted above, reimbursement may be sent directly to the retailer in some instances.

While the invention has been described in its presently preferred form, it will be understood that the invention is capable of modification without departing from the spirit of the invention as set forth in the appended claims.

1. A method of facilitating reimbursement for a qualified medical care product from a reimbursement account, comprising:
providing an indicator that the qualified medical care product is eligible or may be eligible for reimbursement;
providing a reimbursement claim mechanism in connection with the qualified medical care product; and
processing a reimbursement claim for the qualified medical care product.

2. The method of claim 1 wherein the indicator is further defined as a certification mark.

3. The method of claim 1 wherein the indicator is connected to packaging of the qualified medical care product.

4. The method of claim 1 wherein the indicator is placed on an advertising display proximate to the qualified medical care product.

5. The method of claim 1 wherein the reimbursement claim mechanism is further defined as a claim form placed in packaging of the product.

6. The method of claim 5 wherein the claim form identifies the qualified medical care product being purchased and is configured to receive information regarding purchase price, purchase date, and a participant associated with the reimbursement account.

7. The method of claim 1 wherein the reimbursement claim mechanism is further defined as information identifying the reimbursement account presented contemporaneously with the purchase of the qualified medical care product.

8. The method of claim 7 wherein the identifying information is a participant identifying number embodied on a card.

9. The method of claim 1 wherein the reimbursement claim is reimbursed from a reimbursement account established in accordance with §125 of the Internal Revenue Code.

10. The method of claim 1 wherein the reimbursement claim is reimbursed from a reimbursement arrangement established in accordance with §105 of the Internal Revenue Code.

11. The method of claim 1 wherein the reimbursement claim is reimbursed from a reimbursement account established in accordance with §223 of the Internal Revenue Code.

12. The method of claim 1 wherein the step of reimbursing further comprises reimbursing the lesser amount of either a requested amount or a manufacturer's wholesale price.

13. A method of facilitating reimbursement for a qualified medical care product from a reimbursement account, comprising:
advertising that a qualified medical care product is eligible for or may be eligible for reimbursement;
providing a reimbursement claim mechanism in connection with the qualified medical care product; and
reimbursing a reimbursement claim for the qualified medical care product upon receipt of the reimbursement claim mechanism from a participant of a plan.

14. The method of claim 13 wherein the step of advertising further comprises placing an indicator on the qualified medical care product, where the indicator signifies that the qualified medical care product is eligible or may be eligible for reimbursement.

15. The method of claim 14 wherein the indicator is further defined as a certification mark.

16. The method of claim 13 wherein the reimbursement claim mechanism is further defined as a claim form placed in packaging of the product.

17. A method for obtaining reimbursement for a qualified medical care product from a reimbursement account, comprising:
receiving a reimbursement claim form in connection with the purchase of the qualified medical care product;
submitting the reimbursement claim form to an entity responsible for administering the reimbursement account; and
receiving reimbursement for the qualified medical care product from said entity.

18. The method of claim 17 further comprises purchasing the qualified medical care product after viewing an advertisement that the qualified medical care product is eligible for or may be eligible for reimbursement;

19. A method for obtaining reimbursement for a qualified medical care product from a reimbursement account, comprising:
selecting a qualified medical care product for purchase;
transacting a purchase of the qualified medical care product; and
initiating a reimbursement claim for the qualified medical care product substantially contemporaneously with the purchase transaction.
